(19) United States
(12) Patent Application Publication
(10) Pub. No.: US 2026/0191209 A1
(43) Pub. Date: Jul. 9, 2026

(54) METHOD OF MAKING BREAD CRUMBS

(71) Applicant: MANSEOK EOM, Fort Lee, NJ (US)

(72) Inventor: MANSEOK EOM, Fort Lee, NJ (US)

(21) Appl. No.: 19/012,996

(22) Filed: Jan. 8, 2025

(51) Int. Cl. A21D 8/02; A21D 6/00; A23L 7/157

(52) U.S. Cl. CPC A21D 8/02; A21D 6/00; A23L 7/157

(57) ABSTRACT

The present invention is a method of making bread crumbs that includes a dough mixing process, a dough kneading process, a first dough proofing process, a dough shaping process, a dough flattening process, a dough scrolling process, a dough roping process, a dough folding process, a dough braiding process, a dough twisting process, a second dough proofing process, a baking process, a cooling process, and a grinding process.

### TECHNICAL FIELD & BACKGROUND

The present invention is generally related to bread crumbs, and in particular, to a method of making improved bread crumbs.

Conventional bread crumbs are made from steamed, crustless white bread that's been processed into flakes and dried. They are often used to coat fried foods, like pork cutlets (tonkatsu) or fried shrimp to give them extra crunch.

However, some people find conventional bread crumbs have a texture too hard to consume due to their dryness. Moreover, conventional bread crumbs often have a greasy taste because sometimes they can actually absorb more oil during frying compared to traditional breadcrumbs due to their dryness.

Therefore, it would be desirable to provide a method of making bread crumbs that could provide not only a softer texture but also a lighter and crunchier taste without having such hard texture or greasy taste after frying.

### SUMMARY OF THE INVENTION

The present invention is directed to a method of making bread crumbs that overcomes the above-mentioned disadvantages of the prior art.

In one aspect, the present invention provides a method of making bread crumbs having a dough mixing process, a dough kneading process, a first dough proofing process, a dough shaping process, a dough flattening process, a dough scrolling process, a dough roping process, a dough folding process, a dough braiding process, a dough twisting process, a second dough proofing process, a baking process, a cooling process, and a grinding process. The dough mixing process is performed to combine, in baker's percentages, about 100% high gluten flour, about 5% sugar, about 2% salt, about 4% yeast, about 10% milk, about 10% to about 15% egg, about 7% margarine, and about 50% to about 55% water to form a dough mixture. The dough kneading process is performed to knead the dough mixture for 6 to 8 minutes. The first dough proofing process is performed to allow the kneaded dough mixture to rest in an opened container at a room-temperature of 25° C. to 32° C. for 20 to 30 minutes to undergo fermentation and rise. The dough shaping process is performed to mold the proofed dough mixture into a round-shaped dough piece. The dough flattening process is performed to roll the shaped dough piece with a rolling pin to form a dough sheet. The dough scrolling process is performed to roll the flattened dough piece to form a scroll. The dough roping process is performed to roll out the scrolled dough piece to elongate and form a strand. The dough folding process is performed to fold the roped dough piece in half to create two strands of equal length. The dough braiding process is performed to intertwine the folded dough piece by applying a rotational force in a specific pattern to create striations within the dough piece. The dough twisting process is performed to twist the braided dough piece at a specific angle and speed to further enhance the striations within the braided dough piece. The second dough proofing process is performed to allow the twisted dough piece to rest in an opened container at a room-temperature of 25° C. to 32° C. for 35 to 45 minutes to undergo further fermentation and rise. The baking process is performed to bake the proofed dough piece at about 180° C. for 35 to 45 minutes. The cooling process is performed to allow the baked dough piece to cool to rest in an opened container at a room-temperature of 25° C. to 32° C. for about 30 minutes. The grinding process is performed to grind the cooled dough piece by inserting the cooled dough piece lengthwise into a shredder machine to create elongated-shaped crumbs.

In another aspect, the present invention provides a method of making bread crumbs having a dough mixing process, a dough kneading process, a first dough proofing process, a dough shaping process, a dough flattening process, a dough scrolling process, a dough roping process, a dough folding process, a dough braiding process, a dough twisting process, a second dough proofing process, a baking process, a cooling process, a grinding process, and a sieving process. The dough mixing process is performed to combine high gluten flour, sugar, salt, yeast, milk, egg, margarine, and water to form a dough mixture. The dough kneading process is performed to knead the dough mixture for 6 to 8 minutes. The first dough proofing process is performed to allow the kneaded dough mixture to rest in an opened container at a room-temperature of 25° C. to 32° C. for 20 to 30 minutes to undergo fermentation and rise. The dough shaping process is performed to mold the proofed dough mixture into a round-shaped dough piece. The dough flattening process is performed to roll the shaped dough piece with a rolling pin to form a dough sheet. The dough scrolling process is performed to roll the flattened dough piece to form a scroll. The dough roping process is performed to roll out the scrolled dough piece to elongate and form a strand. The dough folding process is performed to fold the roped dough piece in half to create two strands of equal length. The dough braiding process is performed to intertwine the folded dough piece by applying a rotational force in a specific pattern to create striations within the dough piece. The dough twisting process is performed to twist the braided dough piece at a specific angle and speed to further enhance the striations within the braided dough piece. The second dough proofing process is performed to allow the twisted dough piece to rest in an opened container at a room-temperature of 25° C. to 32° C. for 35 to 45 minutes to undergo further fermentation and rise. The baking process is performed to bake the proofed dough piece at about 180° C. for 35 to 45 minutes. The cooling process is performed to allow the baked dough piece to cool to rest in an opened container at a room-temperature of 25° C. to 32° C. for about 30 minutes. The grinding process is performed to grind the cooled dough piece by inserting the cooled dough piece lengthwise into a shredder machine to create elongated-shaped crumbs. The sieving process is performed to sieve the elongated-shaped crumbs to ensure uniform size distribution.

In a further aspect, the present invention provides a method of making bread crumbs having a dough mixing process, a dough kneading process, a first dough proofing process, a dough shaping process, a dough flattening process, a dough scrolling process, a dough roping process, a dough braiding process, a dough twisting process, a second dough proofing process, a baking process, a cooling process, and a grinding process. The dough mixing process is performed to combine, in baker's percentages, about 100% high gluten flour, about 5% sugar, about 2% salt, about 4% yeast, about 10% milk, about 10% to about 15% egg, about 7% margarine, and about 50% to about 55% water to form a dough mixture. The dough kneading process is performed to knead the dough mixture for 6 to 8 minutes. The first dough proofing process is performed to allow the kneaded dough mixture to rest in an opened container at a room-temperature of 25° C. to 32° C. for 20 to 30 minutes to undergo fermentation and rise. The dough shaping process is performed to mold the proofed dough mixture into round-shaped dough pieces. The dough flattening process is performed to roll the shaped dough pieces with a rolling pin to form dough sheets. The dough scrolling process is performed to roll the flattened dough pieces to form scrolls. The dough roping process is performed to roll out the scrolled dough pieces to elongate and form strands. The dough braiding process is performed to intertwine the roped dough pieces by applying a rotational force in a specific pattern to create striations within the dough pieces. The dough twisting process is performed to twist the braided dough pieces at a specific angle and speed to further enhance the striations within the braided dough pieces. The second dough proofing process is performed to allow the twisted dough pieces to rest in an opened container at a room-temperature of 25° C. to 32° C. for 35 to 45 minutes to undergo further fermentation and rise. The baking process is performed to bake the proofed dough pieces at about 180° C. for 35 to 45 minutes. The cooling process is performed to allow the baked dough pieces to cool to rest in an opened container at a room-temperature of 25° C. to 32° C. for about 30 minutes. The grinding process is performed to grind the cooled dough piece by inserting the cooled dough pieces lengthwise into a shredder machine to create elongated-shaped crumbs.

### BRIEF DESCRIPTION OF THE DRAWINGS

N/A

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments. Various operations will be described as multiple discrete operations, in turn, in a manner that is most helpful in understanding the present invention. However, the order of description should not be construed as to imply that these operations are necessarily order dependent. In particular, these operations need not be performed in the order of presentation. The phrase “in one embodiment” is used repeatedly. The phrase generally does not refer to the same embodiment, however, it may. The terms “comprising”, “having” and “including” are synonymous, unless the context dictates otherwise.

The present invention provides a method of making bread crumbs that could provide not only a softer texture but also a lighter and crunchier taste without having hard texture or greasy taste after frying.

The formulations stated in the present specification are generally expressed in baker's percentages, which are weight percentages based on the weight of flour used in a specific recipe (generally per 100 g of flour). For example, for 100 g of flour in a recipe, 55 percent water and 1.7 percent salt would mean the addition of 55 g of water and 1.7 g of salt, respectively, to 100 g of flour. Of course, such baker's percentages do not normally add up to 100 percent. Conventional percentages can be calculated from baker's percentages by normalizing to 100 percent.

In a preferred embodiment of the invention, a method of making bread crumbs includes a dough mixing process, a dough kneading process, a first dough proofing process, a dough shaping process, a dough flattening process, a dough scrolling process, a dough roping process, a dough folding process, a dough braiding process, a dough twisting process, a second dough proofing process, a baking process, a cooling process, a grinding process, and a sieving process.

The dough mixing process is performed to combine high gluten flour, sugar, salt, yeast, milk, egg, margarine, and water to form a dough mixture.

Preferably, the dough mixing process is performed to combine, in baker's percentages, about 100% high gluten flour, about 5% sugar, about 2% salt, about 4% yeast, about 10% milk, about 10% to about 15% egg, about 7% margarine, and about 50% to about 55% water to form a dough mixture.

It is also preferred that the dough mixing process is performed to combine, in baker's percentages, about 100% high gluten flour, about 4% to about 5% sugar, about 2% to about 3% salt, about 4% to about 5% yeast, about 10% to about 13% milk, about 13% to about 18% egg, about 6% to about 8% margarine, and about 50% to about 55% water to form a dough mixture.

Preferably, the high gluten flour is selected from the group consisting of hard wheat flour, soft wheat flour, and combinations thereof. It is also preferred that the dough mixing process is performed by a mixer having a low rotational speed for less than 5 minutes.

The dough kneading process is performed to knead the dough mixture for 6 to 8 minutes.

The first dough proofing process is performed to allow the kneaded dough mixture to rest in an opened container at a room-temperature of 25° C. to 32° C. for 20 to 30 minutes to undergo fermentation and rise.

The dough shaping process is performed to mold the proofed dough mixture into a round-shaped dough piece.

Preferably, the shaped dough piece weighs about 1000 g to about 1200 g. The shaped dough piece may also weight about 500 g to about 600 g.

The dough flattening process is performed to roll the shaped dough piece with a rolling pin to form a dough sheet.

The dough scrolling process is performed to roll the flattened dough piece to form a scroll.

The dough roping process is performed to roll out the scrolled dough piece to elongate and form a strand.

The dough folding process is performed to fold the roped dough piece in half to create two strands of equal length.

The dough braiding process is performed to intertwine the folded dough piece by applying a rotational force in a specific pattern to create striations within the dough piece.

The dough twisting process is performed to twist the braided dough piece at a specific angle and speed to further enhance the striations within the braided dough piece. Preferably, the method can further include the step of twisting the twisted dough piece at a specific angle and speed to further enhance the striations at a room-temperature of 25° C. to 32° C. for about 10 minutes.

The second dough proofing process is performed to allow the twisted dough piece to rest in an opened container at a room-temperature of 25° C. to 32° C. for 35 to 45 minutes to undergo further fermentation and rise.

The baking process is performed to bake the proofed dough piece at about 180° C. for 35 to 45 minutes.

Preferably, when the proofed dough piece is placed in an opened container at a room-temperature and baked without being pre-heating, it results in a well-balanced brown color and reduces baking irregularities in the baked dough piece.

The cooling process is performed to allow the baked dough piece to cool to rest in an opened container at a room-temperature of 25° C. to 32° C. for about 30 minutes.

The grinding process is performed to grind the cooled dough piece by inserting the cooled dough piece lengthwise into a shredder machine to create elongated-shaped crumbs. Preferably, the crumbs are dried to a moisture content of about 30 to about 35 % by weight.

The sieving process sieves the elongated-shaped crumbs to ensure uniform size distribution.

Most importantly, the method disclosed in the present invention involves a complicated process employing time, temperature and relative moisture content to produce improved bread crumbs. The optimal time, temperature and relative moisture content are generally different for bread, conventional bread crumbs and such improved bread crumbs, not only with regard to their appearance (crust color, size, etc.), but also with regard to the development, texture, and size. One of the desirable changes caused by baking such improved bread crumbs is the moisture content. Many factors may be involved in preparing bread crumbs which is appealing in the eyes of the ultimate consumer. A baker must also take into account factors such as how a consumer will perceive the taste of the final product of bread crumbs. One of the most important factors is the moisture content. Consequently, the specified percentages and steps disclosed herein provide such optimal ratio and method for formulating such optimal moisture content in bread crumbs. As a result, when the dough mixture is kneaded, allowed to rest in an opened container at a room-temperature, and then baked as the method disclosed herein, it achieves enhanced hydration, resulting in superior bread crumbs that not only have a softer texture but also have a lighter and crunchier taste that conventional bread crumbs do not have. This is an unexpected result found by the applicant and serves as a fundamental basis of the present invention.

In an exemplary embodiment, a method of making bread crumbs includes a dough mixing process, a dough kneading process, a first dough proofing process, a dough shaping process, a dough flattening process, a dough scrolling process, a dough roping process, a dough braiding process, a dough twisting process, a second dough proofing process, a baking process, and a cooling process.

The dough mixing process combines, in baker's percentages, about 100% high gluten flour, about 5% sugar, about 2% salt, about 4% yeast, about 10% milk, about 10% to about 15% egg, about 7% margarine, and about 50% to about 55% water to form a dough mixture. Preferably, the high gluten flour is selected from the group consisting of hard wheat flour, soft wheat flour, and combinations thereof. Preferably, the dough mixing process is performed by a mixer having a low rotational speed for less than 5 minutes. The dough kneading process is performed to knead the dough mixture for 6 to 8 minutes. The first dough proofing process is performed to allow the kneaded dough mixture to rest in an opened container at a room-temperature of 25° C. to 32° C. for 20 to 30 minutes to undergo fermentation and rise.

The dough shaping process is performed to mold the proofed dough mixture into round-shaped dough pieces. It is preferable that the dough shaping process is performed to mold and divide the proofed dough mixture into equal-sized pieces.

Preferably, the shaped dough pieces weigh about 500 g to about 600 g each. The dough flattening process is performed to roll the shaped dough pieces with a rolling pin to form dough sheets.

The dough scrolling process is performed to roll the flattened dough pieces to form scrolls.

The dough roping process is performed to roll out the scrolled dough pieces to elongate and form strands. The dough braiding process is performed to intertwine the roped dough pieces by applying a rotational force in a specific pattern to create striations within the dough pieces.

The dough twisting process is performed to twist the braided dough pieces at a specific angle and speed to further enhance the striations within the braided dough pieces. Preferably, the method can further include the step of twisting the twisted dough pieces at a specific angle and speed to further enhance the striations at a room-temperature of 25° C. to 32° C. for about 10 minutes.

The second dough proofing process is performed to allow the twisted dough pieces to rest in an opened container at a room-temperature of 25° C. to 32° C. for 35 to 45 minutes to undergo further fermentation and rise.

The baking process is performed to bake the proofed dough pieces at about 180° C. for 35 to 45 minutes.

Preferably, when the proofed dough pieces are placed in an opened container at a room-temperature and baked without being pre-heating, it results in a well-balanced brown color and reduces baking irregularities in the baked dough pieces.

The cooling process is performed to allow the baked dough pieces to cool to rest in an opened container at a room-temperature of 25° C. to 32° C. for about 30 minutes.

The grinding process is performed to grind the cooled dough piece by inserting the cooled dough pieces lengthwise into a shredder machine to create elongated-shaped crumbs. Preferably, the crumbs are dried to a moisture content of about 30% to about 35% by weight.

Thus, the present invention disclosed herein provides a method of making bread crumbs that could provide not only a softer texture but also a lighter and crunchier taste without having hard texture or greasy taste by implementing the method disclosed herein. While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method of making bread crumbs, comprising:
a dough mixing process of combining, in baker's percentages, about 100% high gluten flour, about 5% sugar, about 2% salt, about 4% yeast, about 10% milk, about 10% to about 15% egg, about 7% margarine, and about 50% to about 55% water to form a dough mixture;
a dough kneading process of kneading the dough mixture for 6 to 8 minutes;
a first dough proofing process of allowing the kneaded dough mixture to rest in an opened container at a room-temperature of 25° C. to 32° C. for 20 to 30 minutes to undergo fermentation and rise;
a dough shaping process of molding the proofed dough mixture into a round-shaped dough piece;
a dough flattening process of rolling the shaped dough piece with a rolling pin to form a dough sheet;
a dough scrolling process of rolling the flattened dough piece to form a scroll;
a dough roping process of rolling out the scrolled dough piece to elongate and form a strand;
a dough folding process of folding the roped dough piece in half to create two strands of equal length;
a dough braiding process of intertwining the folded dough piece by applying a rotational force in a specific pattern to create striations within the dough piece;
a dough twisting process of twisting the braided dough piece at a specific angle and speed to further enhance the striations within the braided dough pieces;
a second dough proofing process of allowing the twisted dough piece to rest in an opened container at a room-temperature of 25° C. to 32° C. for 35 to 45 minutes to undergo further fermentation and rise;
a baking process of baking the proofed dough piece at about 180° C. for 35 to 45 minutes;
a cooling process of allowing the baked dough piece to cool to rest in an opened container at a room-temperature of 25° C. to 32° C. for about 30 minutes; and
a grinding process of grinding the cooled dough piece by inserting the cooled dough piece lengthwise into a shredder machine to create elongated-shaped crumbs.

2. The method according to claim 1, wherein the high gluten flour is selected from the group consisting of hard wheat flour, soft wheat flour, and combinations thereof.

3. The method according to claim 1, wherein the shaped dough piece weighs about 500 g to about 600 g.

4. The method according to claim 1, wherein the shaped dough piece weighs about 1000 g to about 1200 g.

5. The method according to claim 1, further comprising the step of twisting the twisted dough piece at a specific angle and speed to further enhance the striations at a room-temperature of 25° C. to 32° C. for about 10 minutes.

6. The method according to claim 1, wherein the dough mixing process is performed by a mixer having a low rotational speed for less than 5 minutes.

7. The method according to claim 1, wherein the crumbs are dried to a moisture content of about 30% to about 35% by weight.

8. A method of making bread crumbs, comprising:
a dough mixing process of combining high gluten flour, sugar, salt, yeast, milk, egg, margarine, and water to form a dough mixture;
a dough kneading process of kneading the dough mixture for 6 to 8 minutes;
a first dough proofing process of allowing the kneaded dough mixture to rest in an opened container at a room-temperature of 25° C. to 32° C. for 20 to 30 minutes to undergo fermentation and rise;
a dough shaping process of molding the proofed dough mixture into a round-shaped dough piece;
a dough flattening process of rolling the shaped dough piece with a rolling pin to form a dough sheet;
a dough scrolling process of rolling the flattened dough piece to form a scroll;
a dough roping process of rolling out the scrolled dough piece to elongate and form a strand;
a dough folding process of folding the roped dough piece in half to create two strands of equal length;
a dough braiding process of intertwining the folded dough piece by applying a rotational force in a specific pattern to create striations within the dough piece;
a dough twisting process of twisting the braided dough piece at a specific angle and speed to further enhance the striations within the braided dough piece;
a second dough proofing process of allowing the twisted dough piece to rest in an opened container at a room-temperature of 25° C. to 32° C. for 35 to 45 minutes to undergo further fermentation and rise;
a baking process of baking the proofed dough piece without being pre-heating at about 180° C. for 35 to 45 minutes;
a cooling process of allowing the baked dough piece to cool to rest in an opened container at a room-temperature of 25° C. to 32° C. for about 30 minutes;
a grinding process of grinding the cooled dough piece by inserting the cooled dough piece lengthwise into a shredder machine to create elongated-shaped crumbs; and
a sieving process of sieving the elongated-shaped crumbs to ensure uniform size distribution.

9. The method according to claim 8, wherein the high gluten flour is selected from the group consisting of hard wheat flour, soft wheat flour, and combinations thereof.

10. The method according to claim 8, wherein the shaped dough piece weighs about 500 g to about 600 g.

11. The method according to claim 8, wherein the shaped dough piece weighs about 1000 g to about 1200 g.

12. The method according to claim 8, further comprising the step of twisting the twisted dough piece at a specific angle and speed to further enhance the striations at a room-temperature of 25° C. to 32° C. for about 10 minutes.

13. The method according to claim 8, wherein the dough mixing process is performed by a mixer having a low rotational speed for less than 5 minutes.

14. The method according to claim 8, wherein the crumbs are dried to a moisture content of about 30% to about 35 % by weight.

15. A method of making bread crumbs, comprising:
a dough mixing process of combining, in baker's percentages, about 100% high gluten flour, about 5% sugar, about 2% salt, about 4% yeast, about 10% milk, about 10% to about 15% egg, about 7% margarine, and about 50% to about 55% water to form a dough mixture;
a dough kneading process of kneading the dough mixture for 6 to 8 minutes;
a first dough proofing process of allowing the kneaded dough mixture to rest in an opened container at a room-temperature of 25° C. to 32° C. for 20 to 30 minutes to undergo fermentation and rise;
a dough shaping process of molding the proofed dough mixture into round-shaped dough pieces;
a dough flattening process of rolling the shaped dough pieces with a rolling pin to form dough sheets;
a dough scrolling process of rolling the flattened dough pieces to form scrolls;
a dough roping process of rolling out the scrolled dough pieces to elongate and form strands;
a dough braiding process of intertwining the roped dough pieces by applying a rotational force in a specific pattern to create striations within the dough pieces;
a dough twisting process of twisting the braided dough pieces at a specific angle and speed to further enhance the striations within the braided dough pieces;
a second dough proofing process of allowing the twisted dough pieces to rest in an opened container at a room-temperature of 25° C. to 32° C. for 35 to 45 minutes to undergo further fermentation and rise;
a baking process of baking the proofed dough pieces at about 180° C. for 35 to 45 minutes;
a cooling process of allowing the baked dough pieces to cool to rest in an opened container at a room-temperature of 25° C. to 32° C. for about 30 minutes; and
a grinding process of grinding the cooled dough piece by inserting the cooled dough pieces lengthwise into a shredder machine to create elongated-shaped crumbs.

16. The method according to claim 15, wherein the high gluten flour is selected from the group consisting of hard wheat flour, soft wheat flour, and combinations thereof.

17. The method according to claim 15, wherein the shaped dough pieces weigh about 500 g to about 600 g each.

18. The method according to claim 15, further comprising the step of twisting the twisted dough pieces at a specific angle and speed to further enhance the striations at a room-temperature of 25° C. to 32° C. for about 10 minutes.

19. The method according to claim 15, wherein the dough mixing process is performed by a mixer having a low rotational speed for less than 5 minutes.

20. The method according to claim 15, wherein the crumbs are dried to a moisture content of about 30% to about 35% by weight.
